(19) United States
(12) Patent Application Publication
(10) Pub. No.: US 2009/0202319 A1
(43) Pub. Date: Aug. 13, 2009

(54) LOCK DEVICE

(75) Inventors: Ting-Jui Wang, Sindian City (TW); Ming-De WU, Sindian City (TW)

Correspondence Address: SCHMEISER, OLSEN & WATTS, 22 CENTURY HILL DRIVE, SUITE 302, LATHAM, NY, 12110, US

(73) Assignee: FIVETECH TECHNOLOGY INC., Sindian City (TW)

(21) Appl. No.: 12/030,276

(22) Filed: Feb. 13, 2008

(51) Int. Cl. F16B 21/08

(52) U.S. Cl. 411/353

(57) ABSTRACT

An improved lock device includes: a ferrule having a through hole disposed at the center of the ferrule, and a groove disposed around the external periphery of the through hole; a locking unit having a force exerted portion and a screw rod that passes through the through hole; a resilient element sheathed onto the screw rod, and an end of the resilient element being disposed in a groove around the ferrule, and another end of the resilient element pressing against a surface of the force exerted portion; and a knob fixed onto the force exerted portion and movably coupled to the ferrule. Therefore, the resilient element can be fixed between the ferrule and the locking unit, and covered with the knob for preventing the resilient element from being damaged by external forces or tilted by external objects to achieve a better stability of using the resilient element.

### FIELD OF THE INVENTION

The present invention relates to an improved lock device, and more particularly to a lock that can provide a better reliability to its application by using a resilient element.

### BACKGROUND OF THE INVENTION

In general, a traditional lock device 7 (as shown in FIGS. 1 and 2) includes a screw 70, a resilient element 8, and a ferrule 9, wherein an end of the screw 70 is a force exerted portion 71, and another end of the screw 70 is a screw rod 72 connected to the force exerted portion 71, and the ferrule 9 is installed at an end of the screw rod 72, and the resilient element 8 is sheathed onto the screw rod 72, and both ends of the resilient element 8 press against the force exerted portion 71 and ferrule 9 respectively. The screw rod 72 is aligned with a screw hole or stud of a desired connecting object, and an external force is applied to rotate the force exerted portion 71 by a tool, such that the force exerted portion 71 compresses the resilient element 8 to lock the screw rod 72 into the screw hole or stud, so as to complete locking the lock device.

Although the traditional lock device 7 can be locked with a secured connecting object, the resilient element 8 is exposed from the screw rod 72, and thus foreign substances or external objects may be adhered onto the resilient element 8. When the force exerted portion 71 compresses the resilient element 8, the resilient element 8 cannot be pressed evenly due to the adhered external objects or other foreign substances, and thus the resilient element 8 is tilted. The resilient element 8 may also be titled when the resilient element 8 is collided or damaged by external forces during the locking process, and cannot be stably positioned between the force exerted portion 71 and the ferrule 9, and thus causing a poor stability of its application.

### SUMMARY OF THE INVENTION

In view of the foregoing shortcomings of the prior art, the inventor of the present invention based on years of experience in the related field to conduct extensive researches and experiments, and finally developed an improved lock device in accordance with the present invention to overcome the shortcomings of the prior art.

Therefore, it is a primary objective of the present invention to fix the resilient element between the ferrule and the locking unit and cover the resilient element in a knob to prevent the resilient element from being damaged or tilted by external forces, so as to achieve a better stability of using the resilient element.

To achieve the foregoing objective, the present invention provides an improved lock device comprising: a ferrule, having a through hole disposed at the center of the ferrule, and a groove disposed around an external periphery of the through hole; a locking unit, having a force exerted portion disposed at an end of the locking unit, and a screw rod disposed at another end of the locking unit, and connected with the force exerted portion and passed through the through hole; a resilient element, sheathed onto the screw rod of the locking unit, and an end of the resilient element being disposed around the groove of the ferrule, and another end of the resilient element being pressed at a surface of the force exerted portion; and a knob, mounted onto the force exerted portion of the locking unit, and movably coupled with the ferrule, for covering the resilient element into the knob.

### BRIEF DESCRIPTION OF THE DRAWINGS

FIG. 1 is a perspective view of a prior art;

FIG. 2 is a cross-sectional view of a prior art;

FIG. 3 is an exploded view of the present invention;

FIG. 4 is a perspective view of the present invention;

FIG. 5 is a cross-sectional view of the present invention;

FIG. 6 is a schematic sectional view of a locked status of the present invention; and

FIG. 7 is a schematic view of a lock device being locked in accordance with the present invention.

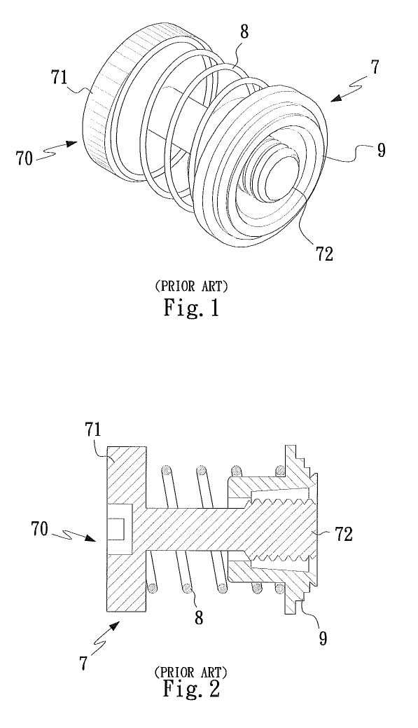

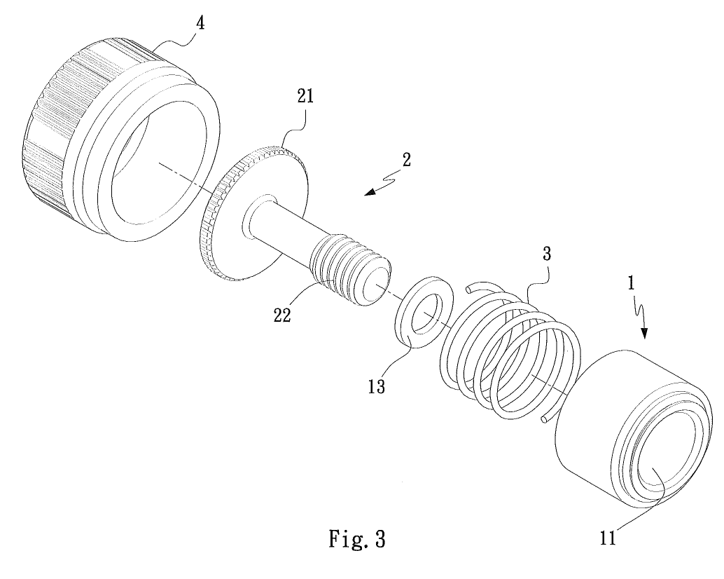

### DESCRIPTION OF THE PREFERRED EMBODIMENT

The above and other objects, features and advantages of the present invention will become apparent from the following detailed description taken with the accompanying drawing.

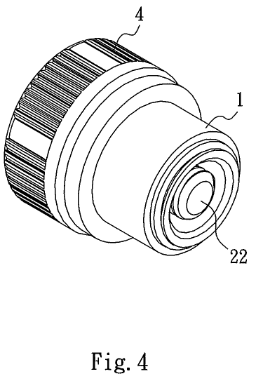

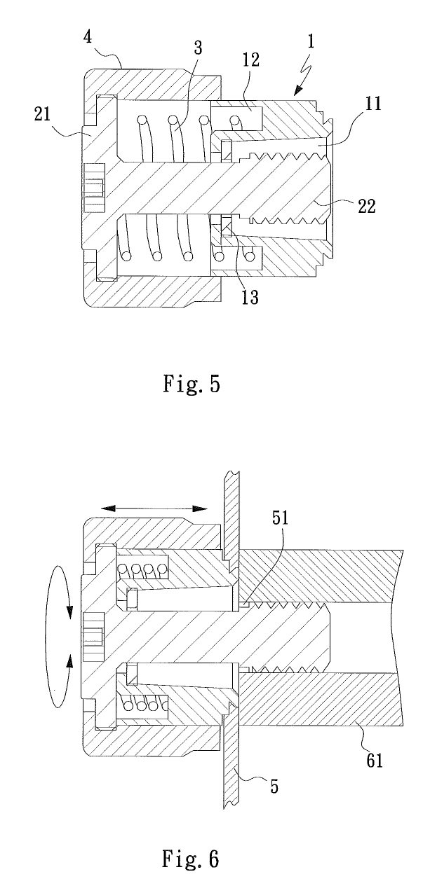

Referring to FIGS. 3 to 5 for an exploded view, a perspective view and a cross-sectional view of the present invention respectively, the present invention provides an improved lock device, comprising a ferrule 1, a locking unit 2, a resilient element 3 and a knob 4.

The ferrule 1 comprises a through hole 11 disposed at the center of the ferrule 1, a groove 12 disposed around an external periphery of the through hole 11, and a washer 13 installed in the through hole 11.

The locking unit 2 has a force exerted portion 21 disposed at an end, and a screw rod 22 disposed at another end, and coupled with the force exerted portion 21, and passed through the through hole 11 and the washer 13.

The resilient element 3 is sheathed onto the screw rod 22 of the locking unit 2, and an end of the resilient element 3 is disposed in the groove 12 around the ferrule 1, and another end of the resilient element 3 presses against a surface of the force exerted portion 21.

The knob 4 is made of an insulating material and coated with a color layer, and the knob 4 is fixed onto the force exerted portion 21 of the locking unit, and movably coupled to the ferrule 1, so that the resilient element 3 can be covered with the knob 4. The aforementioned structure constitutes a novel improved lock device.

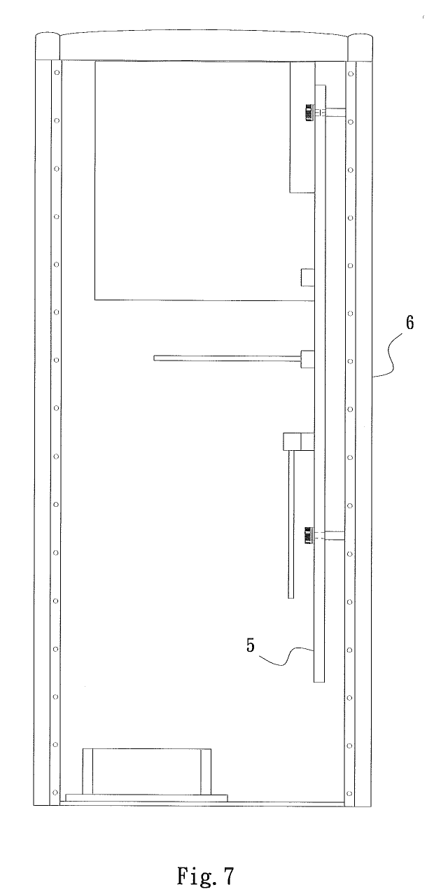

Referring to FIGS. 6 and 7 for a cross-sectional view and a schematic view of a locked status in accordance with the present invention respectively, a connecting plate 5 and a mechanical part 6 are used for illustrating the application of the present invention. The screw rod 22 of the locking unit 2 is aligned with a through hole 51 of the plate 5, and the knob 4 is turned directly, or the force exerted portion 21 of the locking unit 2 is turned by an external force, such that the screw rod 22 is passed through the through hole 51 of the on the plate 5 and locked with a cylindrical body 61 of the mechanical part 6. In the meantime, the screw rod 22 is secured, and thus the knob 4 together with the force exerted portion 21 compress the resilient element 3, and the knob 4 covers the external rim of the ferrule 1, so as to complete the locking action. The resilient element 3 is covered with the knob 4 for effectively isolating the resilient element 3 from the outside and preventing the resilient element 3 from being damaged by external forces or tilted by external objects, so as to provide a better stability for operating the locking unit 2. Further, the knob 4 can be coated with a color layer for reminding a user not to touch the lock device with the surrounding electric circuit or cause a short circuit during the process of removing the lock device. If the user touches the lock device with a surrounding circuit by accident, the knob 4 made of an insulating material can prevent a short circuit caused by the contact of the lock device with the surrounding circuit, so as to adversely affect the electric properties.

In summation of the description above, the improved lock device of the invention can effectively overcome the shortcomings of the prior art by fixing the resilient element between the ferrule and the locking unit and covering the resilient element in the knob. Such arrangement can prevent the resilient element from being damaged by external forces or titled by external objects, so that the resilient element can achieve a better stability of the application. The invention complies with the requirements of patent application, and thus is duly filed for patent application.

While the invention has been described by means of specific embodiments, numerous modifications and variations could be made thereto by those skilled in the art without departing from the scope and spirit of the invention set forth in the claims.

What is claimed is:

1. An improved lock device, comprising:
a ferrule, having a through hole disposed at the center of the ferrule, and a groove disposed around an external periphery of the through hole;
a locking unit, having a force exerted portion disposed at an end of the locking unit, and a screw rod disposed at another end of the locking unit, and connected with the force exerted portion and passed through the through hole;
a resilient element, sheathed onto the screw rod of the locking unit, and an end of the resilient element being disposed around the groove of the ferrule, and another end of the resilient element being pressed at a surface of the force exerted portion; and
a knob, mounted onto the force exerted portion of the locking unit, and movably coupled with the ferrule, for covering the resilient element into the knob.

2. The improved lock device of claim 1, wherein the through hole of the ferrule installs a washer.

3. The improved lock device of claim 1, wherein the knob is made of an insulating material.

4. The improved lock device of claim 1, wherein the knob is coated with a color layer.
